(19) United States
(12) Patent Application Publication
(10) Pub. No.: US 2007/0251791 A1
(43) Pub. Date: Nov. 1, 2007

(54) LOCK-UP CLUTCH

(75) Inventors: Hiromi Fujiwara, Shizuoka-ken (JP); Ryo Mochizuki, Shizuoka-ken (JP); Yoshihiko Ozawa, Shizuoka-ken (JP); Yasutaka Amano, Shizuoka-ken (JP); Akira Tsuboi, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA F.C.C., Shizuoka (JP)

(21) Appl. No.: 11/740,837

(22) Filed: Apr. 26, 2007

(30) Foreign Application Priority Data
Apr. 26, 2006 (JP) 2006-121634

(51) Int. Cl. F16H 45/02

(52) U.S. Cl. 192/3.29; 192/212

(57) ABSTRACT

A lock-up clutch can include a clutch piston arranged within a cover of a torque converter and adapted to be moved between a connected position and a non-connected position relative to the torque converter cover. A containing recess can be formed on a circumferential edge of the clutch piston for containing damper springs and connecting members for connecting a turbine arranged within the torque converter cover and the clutch piston via the damper springs contained within the containing recess. An independent member forming an outer circumferential portion of the containing recess can be arranged oppositely to the outer surface of each damper spring.

### CROSS-REFERENCE TO RELATED APPLICATIONS

The present application is based on and claims priority under 35 U.S.C. §119 to Japanese Patent Application No. 2006-121634, filed on Apr. 26, 2006, the entire contents of which is expressly incorporated by reference herein.

### BACKGROUND OF THE INVENTIONS

1. Field of the Inventions

The present inventions relate to a lock-up clutch for transmitting a torque input from a cover of a torque converter (also known as “a torque converter cover”) to a turbine via a clutch piston and connecting members.

2. Description of the Related Art

Torque converters equipped on AT (automatic transmission) vehicles usually comprise a torque converter cover in which liquid (working fluid) is contained in a normally liquid-tight condition. A pump is rotated together with the torque converter cover. A turbine is usually arranged oppositely to the pump and a stator is connected to a one way clutch. The rotation of pump can be transmitted to the turbine via the liquid with increasing the transmitting torque. Accordingly the driving power of engine can be amplified via the liquid and transmitted to a transmission and driving wheels of a vehicle.

The lock-up clutch is arranged within the torque converter cover and is intended to reduce torque transmitting losses by directly connecting the torque converter cover and the turbine at an appropriate timing as compared with the torque transmission via liquid. For example, the lock-up clutch can have a clutch piston connected to the turbine and can be moved between a connected position in which the clutch piston is abutted to an inner circumferential surface of the torque converter cover and a non-connected position in which the clutch piston and the torque converter cover are separated. As such, the torque converter cover and the turbine can be selectively and directly connected via the clutch piston when it is in the connected position.

Damper springs are usually arranged on the clutch piston for absorbing torque variation from an engine in the connected condition of the lock-up clutch. A plurality of the damper springs can be arranged within an arc shaped containing recess formed along the outer circumferential edge portion of the clutch piston and can thus be displaced to absorb the torque variation transmitted from an engine. For example, Japanese Laid-open Patent Publication No. 126298/1997 discloses such a design.

However, in this type of prior art lock-up clutch, because each damper spring is displaced (i.e. expands and contracts) while it is contained within the arc-shaped containing recess, the outer surface (i.e. the radially outermost surface) of the spring tends to contact the surface of the outer circumferential portion of the containing recess and thereby generates hysteresis by the sliding friction during the displacement of the damper spring.

Such hysteresis tends to increase in proportion to the sliding distance of the damper spring relative to the surface of the containing recess. This increased hysteresis can increase the spring constant of the damper spring and thus lower torque variation absorbing performance. This effect is more significant when the damper spring is arranged in the arc shape. With this arc shape, the outer surface of the damper spring tends to be pressed against the surface of the containing recess and thus the sliding friction between the damper spring and the surface of the containing recess as well as the hysteresis are increased, thereby further lowering the engine torque variation absorbing performance.

### SUMMARY OF THE INVENTIONS

An aspect of at least one of the embodiments disclosed herein includes the realization that such hysteresis issues can be improved by using an additional member disposed between the containing recess of a lock-up clutch and the dampening springs.

Thus, in accordance with at least one of the embodiments disclosed herein, a lock-up clutch can comprise a clutch piston arranged within a torque converter cover and adapted to be moved between a connected position and a non-connected position relative to the torque converter cover. A containing recess can be formed on a circumferential edge of the clutch piston configured to contain damper springs. Connecting members can be configured to connect a turbine arranged within the torque converter cover and the clutch piston via the damper springs contained within the containing recess. A torque input to the torque converter cover can be transmitted to the turbine via the clutch piston and the connecting members when the clutch piston is in the connected position. An independent member can form an outer circumferential wall portion of the containing recess arranged oppositely to the outer surface of each damper spring. The independent member can be separate from the clutch piston so that it can move relative to the clutch piston.

In accordance with another embodiment, a torque converter can comprise a torque converter cover and a torque converter turbine arranged within the torque converter. A clutch piston can be arranged within the torque converter cover and can be adapted to be moved between a connected position and a non-connected position relative to the torque converter cover. A containing recess can be formed on a circumferential edge of the clutch piston configured to contain damper springs. Connecting members can be configured to connect the torque converter turbine and the clutch piston via the damper springs contained within the containing recess. A torque input to the torque converter cover can be transmitted to the turbine via the clutch piston and the connecting members when the clutch piston is in the connected position. An independent member forming an outer circumferential wall portion of the containing recess can be arranged oppositely to the outer surface of each damper spring. The independent member can be separate from the clutch piston so that it can move relative to the clutch piston.

In accordance with yet another embodiment, a lock-up clutch can comprise a clutch piston arranged within a torque converter cover and adapted to be moved between a connected position and a non-connected position relative to the torque converter cover. A containing recess can be formed on a circumferential edge of the clutch piston configured to contain damper springs. Connecting members can be configured to connect a turbine arranged within the torque converter cover and the clutch piston via the damper springs contained within the containing recess. A torque input to the torque converter cover can be transmitted to the turbine via the clutch piston and the connecting members when the clutch piston is in the connected position. Additionally, the lock-up clutch can include means for becoming entrained with the spring, disposed between the springs and the containing recess, for allowing at least portions of the springs to slide relative to the containing recess without rubbing against the containing recess.

### BRIEF DESCRIPTION OF THE DRAWINGS

Additional advantages and features of the present inventions will become apparent from the subsequent description and the appended claims, taken in conjunction with the accompanying drawings, wherein:

FIG. 1 is a cross-sectional view of a torque converter to which an embodiment of a lock-up clutch is applied;

FIG. 2 is a cross-sectional view taken along a line II-II of FIG. 1;

FIG. 3 is a cross-sectional view taken along a line III-III of FIG. 2;

FIG. 4 is a cross-sectional view taken along a line IV-IV of FIG. 2;

FIG. 5 is a partial cutaway view of the lock-up clutch of FIG. 1 showing an exemplary positional relationship between a damper spring and an independent member in the lock-up clutch, in a condition prior to displacement of the damper spring;

FIG. 6 is a partial cutaway view of the lock-up clutch of FIG. 1 showing an exemplary positional relationship between a damper spring and an independent member in the lock-up clutch, in a condition after displacement of the damper spring;

FIG. 7 is a cross-sectional view of a modification of the lock-up clutch of FIG. 1, in which the damper springs are formed by arranging coil springs having different spring constants in series each other;

FIG. 8 is a cross-sectional view of a further modification of the lock-up clutch of FIG. 1, in which the damper springs are formed by arranging coil springs having different spring constants in parallel each other;

FIG. 9 is a graph showing an exemplary relationship between torsional angle of the damper spring and engine torque from experimental data comparing examples of the present embodiments and the prior art; and

FIG. 10 is a graph showing an exemplary relationship between the median of the torsional torque and the hysteresis torque based on the graph of FIG. 9.

### DETAILED DESCRIPTION OF THE PREFERRED EMBODIMENTS

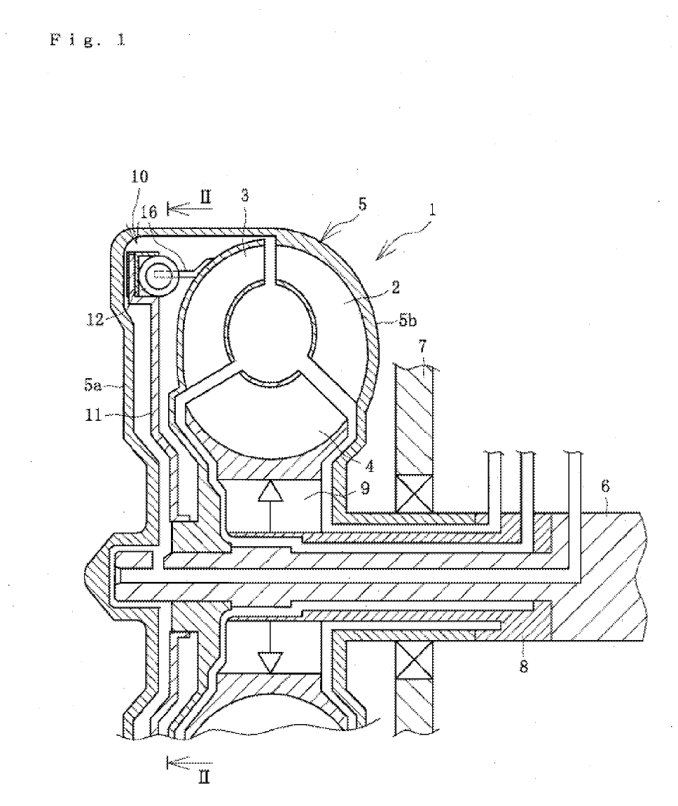

With reference to FIG. 1, a lock-up clutch 1 can be configured to transmit a torque inputted to a cover of a torque converter (i.e. a torque converter cover) to a turbine of the torque converter via a clutch piston and connecting members when the clutch piston is in the connected position.

The torque converter is described in the context of an AT (automatic transmission) vehicle, in which the torque converter transmits a torque from an engine (not shown) to a transmission (not shown) while amplifying the torque, because the present embodiments have particular utility in this contexts. However, the embodiments and inventions disclosed herein can be applied to and used in other contexts as well.

Such a torque converter can comprise a torque converter cover 5 rotatable about its axis to which engine torque and power are transmitted. A liquid (working fluid) can be disposed in the cover 5 in a liquid tight condition. A pump 2 can be formed on a right-hand (in FIG. 1) wall 5b of the torque converter cover 5 and can rotate together with the cover 5. A turbine 3 can be arranged oppositely to the pump 2 at a side of left-hand (FIG. 1) wall 5a and can freely rotate within the cover 5. A stator 4 can be connected to a stator shaft 8 via a one-way clutch 9, and a lock-up clutch 10.

When the torque converter cover 5 and the pump 2 are rotated by driving force from an engine, its rotational torque is transmitted to the turbine 3 via the liquid (working fluid) with the torque being amplified. Accordingly when the turbine 3 is rotated by the amplified torque, an output shaft 6 connected to the turbine 3 via a spline arrangement (not shown) is also rotated and thus the torque is transmitted to the transmission (not shown) of the associated vehicle or device. In FIG. 1 the reference numeral 7 denotes a transmission case.

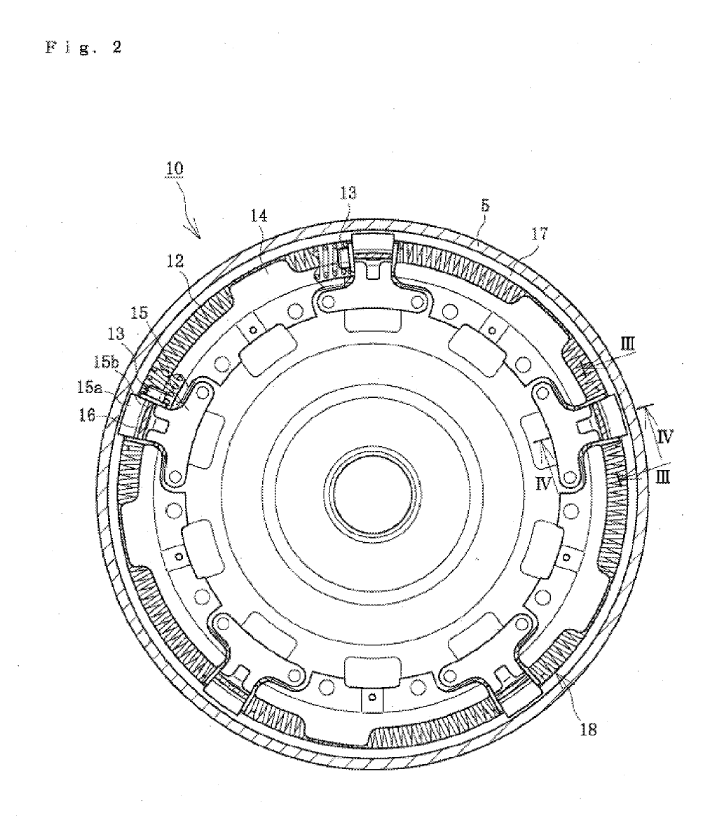

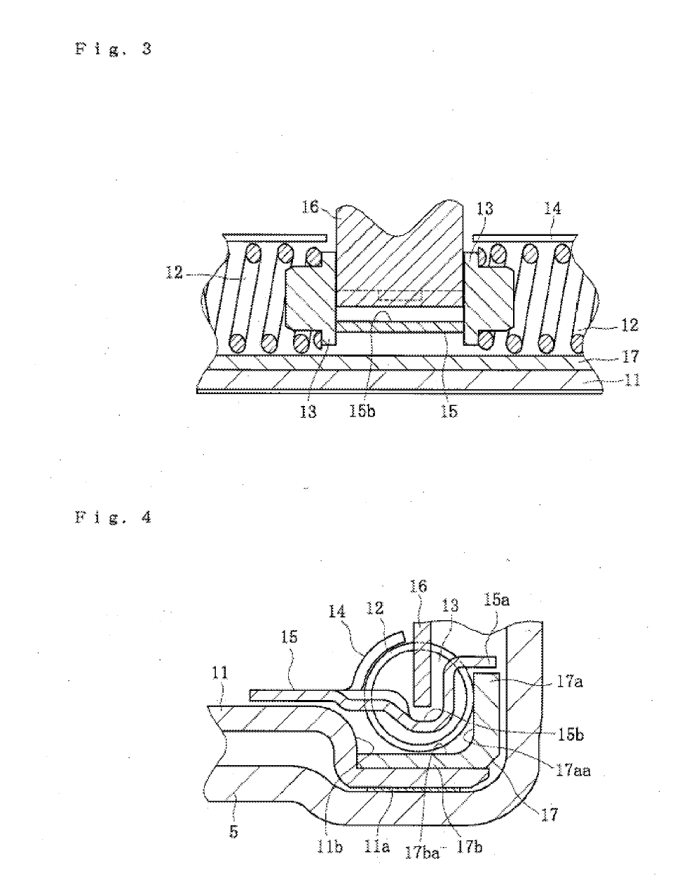

The lock-up clutch 10 can reduce loss of torque transmission, as compared with the torque transmission using only liquid, by directly connecting the torque converter cover 5 and the turbine 3 at an appropriate timing. As shown in FIGS. 2-4, the lock-up clutch 10 can comprise a clutch piston 11 which can be formed by a substantially disc shaped member, a plurality of damper springs 12 formed by circular arc-shaped coil springs bent along their displacement directions (expanding and contracting directions), connecting members 16 for connecting the clutch piston 11 and the turbine 3, and an independent member 17.

The clutch piston 11 can be moved toward the left and right directions (FIG. 1) by switching the liquid pressure of the liquid between the clutch piston 11 and the left-hand side wall 5a of the cover 5 respectively, between negative and non-negative pressures. The clutch piston 11 can be provided with a substantially annular lining 11a (FIG. 4) on its outer circumferential surface at its left-hand side. Accordingly, when the liquid pressure between the clutch piston 11 and the left-hand side wall 5a of the cover 5 is changed to a negative pressure, the clutch piston 11 can abut the inside surface of the left-hand side wall 5a of the torque converter cover 5 via the lining 11a and thus the clutch piston 11 and the torque converter cover 5 can be connected each other (this position is referred to as a “connected position”).

On the other hand, when the negative pressure is released, the clutch piston 11 can separate from the wall 5a of the cover 5 and thus the connection between the clutch piston 11 and the torque converter cover 5 is released (this position is referred to as a “non-connected position”).

On a side of the clutch piston 11 opposite to the side on which the lining 11a is provided, there can be formed a containing recess 18 (FIG. 5) along a circumferential edge of the clutch piston 11. The containing recess 18 can be formed as a circular arc groove for containing damper springs 12.

The containing recess 18 can comprise, as shown in FIG. 4, a stepped surface 11b can be formed by bending the outer circumferential edge of the clutch piston 11, a bottom wall portion 17b (more specifically, its inner surface 17ba) of an independent member 17 described below more in detail (“bottom” meaning a bottom of the containing recess 18), and an outer circumferential wall 17a (more specifically, inner circumferential surface 17aa) of the independent member 17.

Accordingly, outer surfaces (i.e. radially outermost surface) of each damper spring 12 contained in the containing recess 18 can be adapted to be contacted with the inner circumferential surface 17aa by a centrifugal force during rotation of the clutch piston 11 and thus, further radially outward movement of the damper spring 12 is limited by the outer circumferential wall 17a (more specifically, inner circumferential surface 17aa) of the independent member 17. Similarly, movements of the damper spring 12 in axially outward and the inward directions are limited respectively by the bottom wall portion 17b (more specifically, its inner surface 17ba) of an independent member 17 and a guiding member 14 secured on the clutch piston 11.

With reference to FIG. 2, in the illustrated embodiment, five damper springs 12 can be contained in the containing recess 18 and an end piece 13 can be mounted on each end of each damper spring 12. Secured on the clutch piston 11 can be metal damper holders 15 projecting between adjacent damper springs 12 for defining a space for receiving each damper spring 12. Thus each damper spring 12 can be positioned with the end pieces on its opposite ends being abutted to the damper holders 15.

The damper holders 15 can be formed with a bent portion 15b bent toward the containing recess 18. The turbine 3 and the clutch piston 11 can be connected to each other in their rotational direction via the damper springs 12 with the tip end of each connecting portion 16 extending from the turbine 3 being inserted into the bent portion 15b. That is, the side faces of each connecting portion 16 inserted into the bent portion 15b is adapted to be abutted to the end pieces 13 of the damper springs 12 and thus it is possible that the torque variation is absorbed by displacement (i.e. expansion and contract) of the damper springs 12 while torque is transmitted from the clutch piston 11 to the turbine 3 via the connecting portions 16.

Axially inward movement of the independent member 17 can be limited by a tip end 15a of the damper holder 15 extending to the outer circumferential wall 17a of the independent member 17 substantially in parallel with the bottom wall of the independent member 17 as shown in FIG. 4. The radially inward movement of the independent member 17 can be limited with the radially inward end face of the bottom wall 17b of the independent member 17 being abutted to the stepped surface 11b of the clutch piston 11. Radially outward movement of the damper spring caused by the centrifugal force generated by rotation of the lock-up clutch 10 can be limited by the outer circumferential wall 17a of the independent member 17 and thus the damper springs 12 can be prevented from falling out of the containing recess 18.

The independent member 17 can be arranged along the circumferential edge of the clutch piston 11, separate therefrom, and can have a substantially “L” shaped cross section comprising the bottom wall 17b substantially parallel with the clutch piston 11 and the outer circumferential wall 17a extending substantially vertically from the bottom wall 17b.

As previously described, the inner surface 17ba of the bottom wall portion 17b of an independent member 17 is arranged so that it oppositely faces the bottom side surfaces of the damper springs 12 and the outer circumferential wall 17a of the independent member 17 is arranged so that it oppositely faces the radially outermost surfaces of the damper springs 12.

The independent member 17 is separate from the clutch piston 11 and therefore it can be freely rotated relative to the clutch piston 11. Accordingly, the independent member 17 can rotate with the damper springs 12 at an angle relative to the clutch piston 11 when the damper springs 12 are displaced (i.e. expand and contract) and while the radially outermost surfaces of the damper springs 12 are relatively strongly urged to the outer circumferential wall 17a. This makes it possible to reduce the sliding distance of the outer circumferential wall 17a of the damper springs 12 relative to the inner circumferential surface 17aa of the outer circumferential wall 17a of the independent member 17.

It is of course that the sliding distance of the bottom side surfaces of the damper springs 12 relative to the inner surface 17ba of the bottom wall 17b of the independent member 17 can be also reduced. The surfaces 17ba, 17aa of the bottom wall portion 17b and the outer circumferential portion 17a of the independent member 17 can be surface treated to improve their wear resistance.

In operation, when the clutch piston 11 is shifted from its non-connected position to its connected position, the torque transmission path via the liquid is switched to the direct torque transmission path via clutch piston 11 of the lock-up clutch 10. In this direct torque transmission, the engine torque variation is absorbed by the damper springs 12, not by the liquid.

That is, when the torque variation arises during the torque transmission from the clutch piston 11 to the turbine 3 via the connecting members 16, the torque variation can be absorbed by the generation of relative displacement in the rotational direction between the connecting members 16 (i.e. the turbine 3) and the clutch piston 11 and by the compressive displacement (i.e. contraction) of the damper springs 12 within the containing recess 18. The torque (variation of which is attenuated by the damper springs 12) is transmitted to a transmission (not shown) from the turbine 3 via the output shaft 6.

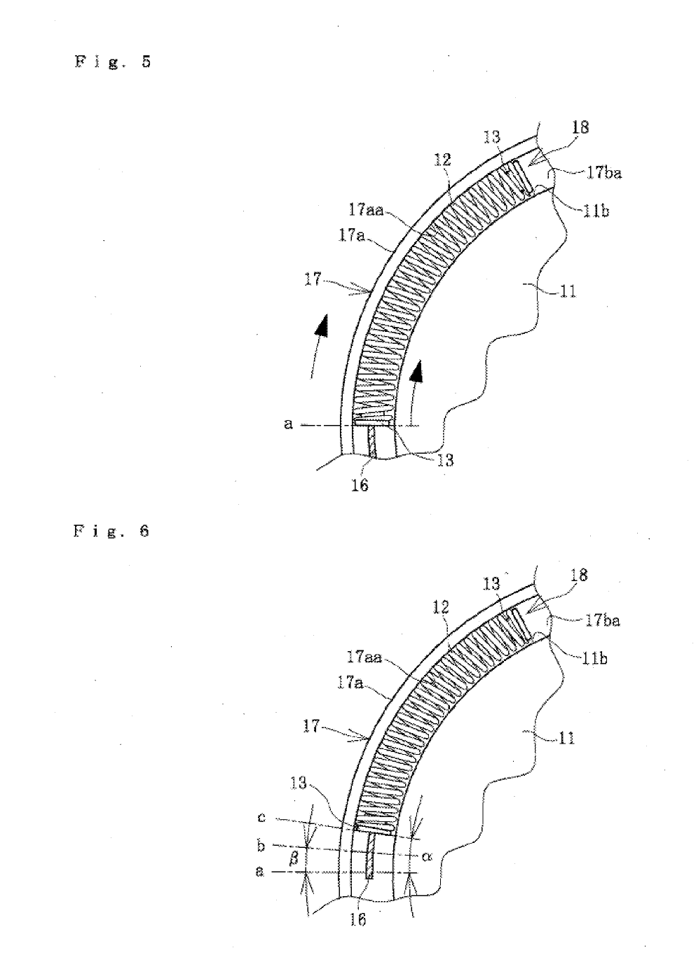

During operation, one end (e.g. end piece 13) of the damper spring 12 can be displaced from their initial positions “a” in FIG. 5, for example, to a position “c” in FIG. 6 when the damper spring 12 is compressed. According to at least some of the present embodiments disclosed herein, the independent member 17 can also be rotated in the same direction to a position “b” shown in FIG. 6 by an angle “β” due to the contact between the damper spring 12 and the independent member 17. This contact can be referred to as the independent member 17 being “entrained” with the damper spring 12.

Without the independent member 17, or a similar device, as in the prior art devices, the sliding distance of the damper spring 12 can be an angle “α” (i.e. from the position “a” to the position “b”). On the other hand, with the independent member 17 provided according to at least some of the present embodiments, the sliding distance becomes a value subtracted the “β” of sliding length of the independent member 17 from “α”.

Thus the reduction of sliding distance of the damper springs 12 relative to the outer circumferential wall 17a contributes to reduction of the hysteresis and thus to improvement of the engine torque variation absorbing performance. In addition, according to at least some of the present embodiments, the independent member 17 can have a substantially “L” shaped cross-section having the outer circumferential wall 17a and the bottom side wall 17b to be arranged oppositely both to the radially outermost surface and the bottom side surface of the damper spring 12. This contributes to further reduction of the hysteresis of the damper springs 12 and thus to further improvement of the engine torque variation absorbing performance.

In addition, since the radially inward movement of the independent member 17 is limited by the stepped portion 11b of the clutch piston 11, faults caused by the provision of the independent member 17 (e.g. falling-out of the damper springs 12 from the containing recess 18 due to radial movement of the independent member 17) can be avoided. Also since the surfaces 17ba, 17aa respective of the bottom wall portion 17b and the outer circumferential portion 17a of the independent member 17 can be surface treated to improve their wear resistance, it is possible to avoid wear both of the independent member 17 and the damper springs 12 for a long term.

Tests providing evidence of some of the technological advantages of at least some of the present embodiments are described below.

These experiments were carried out on a design that is an disclosed in the present disclosure (i.e. an embodiment having the independent member 17) and a comparative example (i.e. that of the prior art having no independent member).

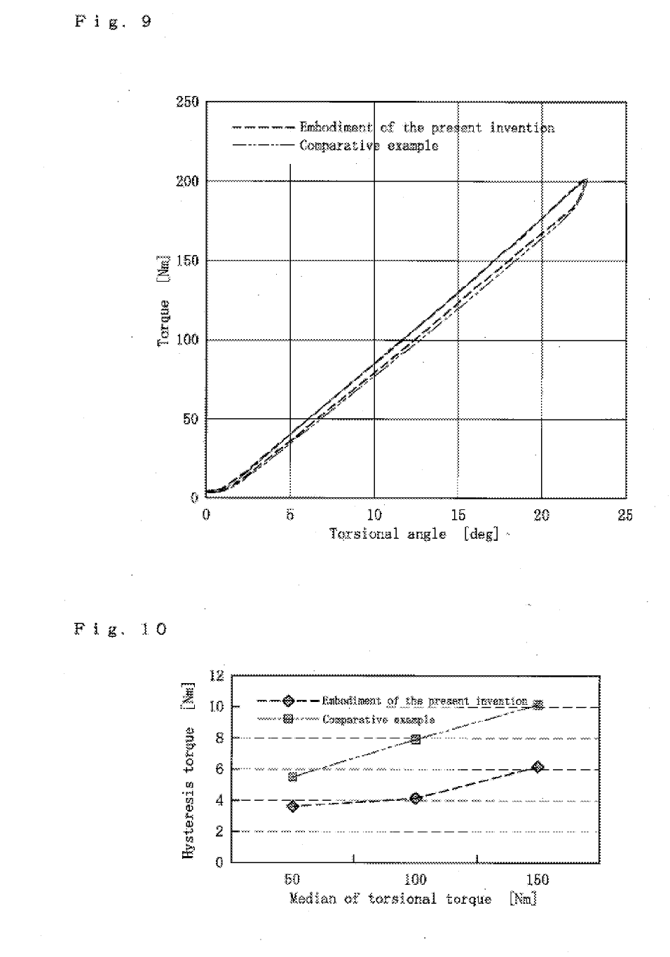

FIG. 9 shows an exemplary relationship between the torsional angle (deg) and torque (Nm). FIG. 10 shows an exemplary relationship between the median of the torsional torque (50 Nm, 100 Nm, 150 Nm) and the hysteresis torque (Nm) based on the relationship of FIG. 9.

As shown in FIGS. 9 and 10, at least some of the embodiments disclosed above exhibit hysteresis torque lower than that of the comparative example of the prior art over the median (50˜150 Nm) of the torsional torque of a predetermined range. For example, at the median 150 Nm of the torsional torque, the hysteresis torque is significantly lower (about 40%) than that of the comparative example. Accordingly it can be appreciated that the embodiments disclosed above can remarkably reduce the hysteresis of the damper springs and thus improve the engine torque variation absorbing performance.

The present inventions has been described with reference to preferred embodiments. Obviously, modifications and alternations will occur to those of ordinary skill in the art upon reading and understanding the preceding detailed description.

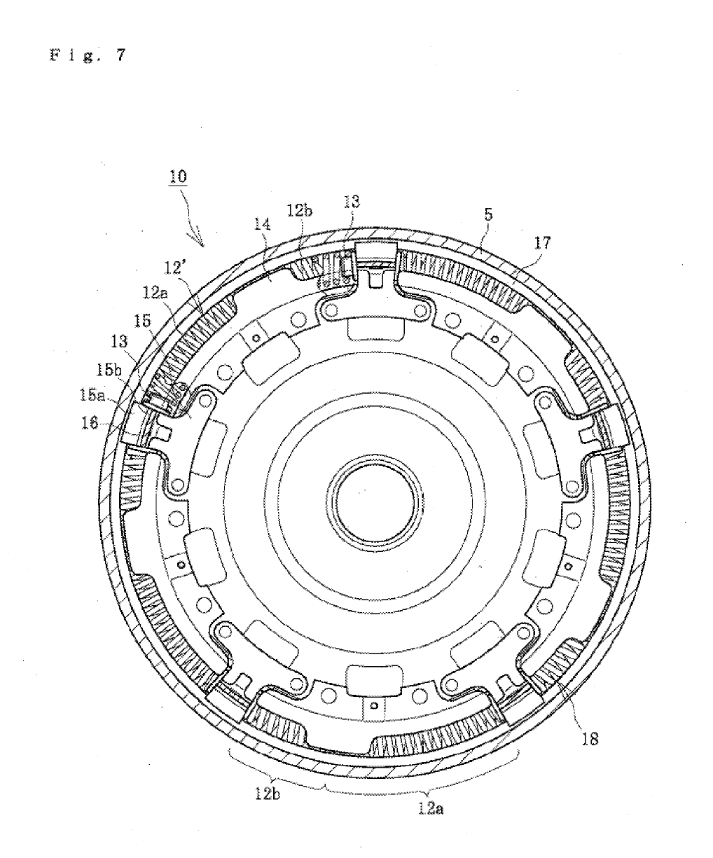

For example as shown in FIG. 7, a damper spring 12′ can be formed by combining, in series, a plurality of coil springs having different spring constants (e.g. a combination of a coil spring 12a having a first spring constant and a coil spring 12b having a relatively higher second spring constant).

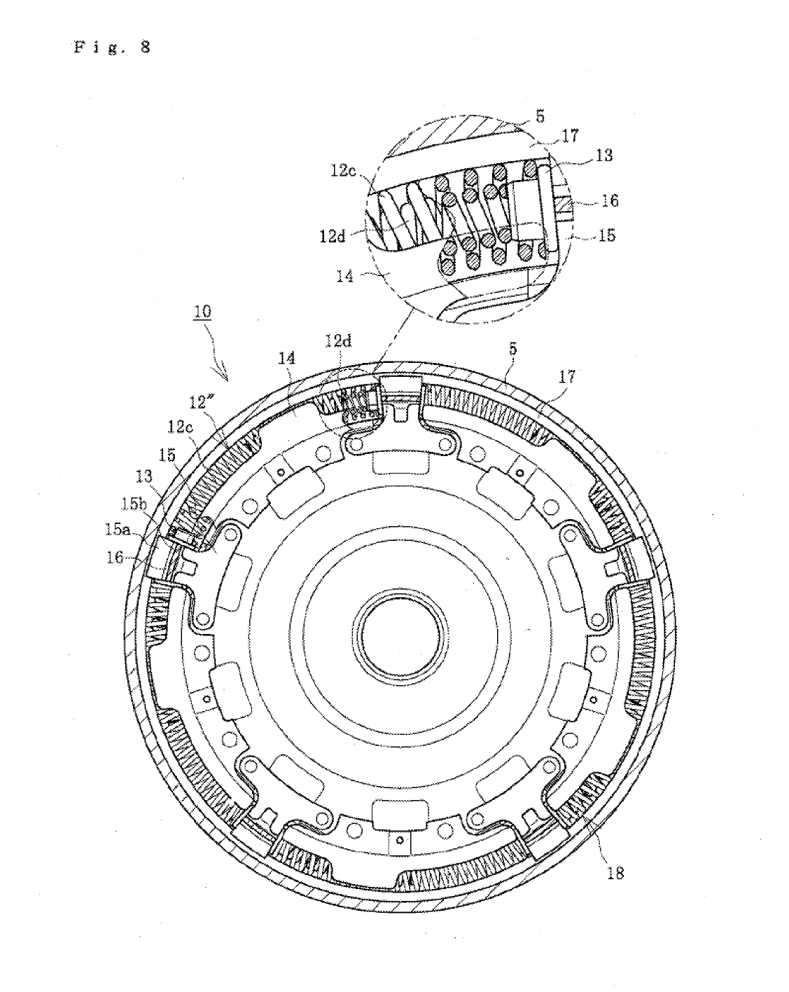

Optionally, as shown in FIG. 8, a damper spring 12″ can be formed by combining, in parallel, a plurality of coil springs having different spring constants (e.g. a combination of a coil spring 12c having a large coil diameter and a coil spring 12d having a small coil diameter, each with different spring constants).

Thus if the damper spring is formed of a plurality of coil springs having different values of spring constant each other, it is possible to appropriately set the characteristics of the damper springs as a whole and thus to obtain a desirable torque variation absorbing performance. In this case it is possible to combine in series or parallel three or more coil springs each having different spring constant.

The lock-up clutches of the embodiments described above can be applied to any lock-up clutch in which an independent member having portions arranged oppositely to the outer surface of damper springs is arranged freely movable relative to a clutch piston.

What is claimed is:

1. A lock-up clutch comprising:
a clutch piston arranged within a torque converter cover and adapted to be moved between a connected position and a non-connected position relative to the torque converter cover;
a containing recess formed on a circumferential edge of the clutch piston configured to contain damper springs; and
connecting members configured to connect a turbine arranged within the torque converter cover and the clutch piston via the damper springs contained within the containing recess, wherein a torque input to the torque converter cover can be transmitted to the turbine via the clutch piston and the connecting members when the clutch piston is in the connected position; and
an independent member forming an outer circumferential wall portion of the containing recess arranged oppositely to the outer surface of each damper spring, the independent member being separate from the clutch piston so that it can move relative to the clutch piston.

2. A lock-up clutch of claim 1, wherein the independent member comprises a substantially “L” shaped member, in cross section, having a bottom wall portion and the outer circumferential portion configured to be arranged oppositely to a recess bottom side surface and the outer surface of an associated damper spring, respectively.

3. A lock-up clutch of claim 2, wherein surfaces respective of the bottom wall portion and the outer circumferential portion of the independent member configured to be arranged oppositely to the recess bottom side surface and the outer surface of each damper spring, respectively, are surface treated to improve their wear resistance.

4. A lock-up clutch of claim 1 wherein the damper springs comprise a plurality of coil springs having different spring constants.

5. A lock-up clutch of claim 2 wherein the damper springs comprise a plurality of coil springs having different spring constants.

6. A lock-up clutch of claim 3 wherein the damper springs comprise a plurality of coil springs having different spring constants.

7. A lock-up clutch of claim 1 in combination with a torque converter.

8. A torque converter comprising:
a torque converter cover;
a torque converter turbine arranged within the torque converter;
a clutch piston arranged within the torque converter cover and adapted to be moved between a connected position and a non-connected position relative to the torque converter cover;
a containing recess formed on a circumferential edge of the clutch piston configured to contain damper springs; and
connecting members configured to connect the torque converter turbine and the clutch piston via the damper springs contained within the containing recess, wherein a torque input to the torque converter cover can be transmitted to the turbine via the clutch piston and the connecting members when the clutch piston is in the connected position; and
an independent member forming an outer circumferential wall portion of the containing recess arranged oppositely to the outer surface of each damper spring, the independent member being separate from the clutch piston so that it can move relative to the clutch piston.

9. A torque converter of claim 7 additionally comprising a pump rotationally connected to the torque converter cover and a working liquid configured to transfer torque from the pump to the turbine.

10. A lock-up clutch comprising:
a clutch piston arranged within a torque converter cover and adapted to be moved between a connected position and a non-connected position relative to the torque converter cover;
a containing recess formed on a circumferential edge of the clutch piston configured to contain damper springs; and
connecting members configured to connect a turbine arranged within the torque converter cover and the clutch piston via the damper springs contained within the containing recess, wherein a torque input to the torque converter cover can be transmitted to the turbine via the clutch piston and the connecting members when the clutch piston is in the connected position; and
means for becoming entrained with the spring, disposed between the springs and the containing recess, for allowing at least portions of the springs to slide relative to the containing recess without rubbing against the containing recess.
